(19) United States
(12) Patent Application Publication
(10) Pub. No.: US 2012/0130763 A1
(43) Pub. Date: May 24, 2012

(54) Method and System of Selecting Representatives Based On Various Criteria

(76) Inventor: Charles Katz, San Francisco, CA (US)

(21) Appl. No.: 13/301,551

(22) Filed: Nov. 21, 2011

Related U.S. Application Data
(60) Provisional application No. 61/416,518, filed on Nov. 23, 2010.

(51) Int. Cl. G06Q 10/06

(52) U.S. Cl. 705/7.14

(57) ABSTRACT

Systems and methods of providing customer support by matching consumers and pre-qualified service representatives are disclosed. Customer-to-business transactions can be facilitated by pre-qualifying both consumers and service representatives and matching the consumers to the corresponding representatives. For example, according to one exemplary embodiment, using information provided by the consumers, such as language spoken, expertise, rating, response time, etc., a matching system can determine a list of single, pre-qualified service representatives that matches or meets the needs of the consumers.

### INCORPORATION BY REFERENCE

This application claims the benefit of priority under 35 U.S.C. 119(e) to the filing date of U.S. provisional patent application No. 61/416,518 “Method of Selecting Representatives Based on Various Criteria” which was filed on Nov. 23, 2010, and which is incorporated herein by reference in its entirety.

### FIELD OF THE INVENTION

Embodiment of the present invention relates to a method and system for managing customer service. Specifically, embodiments of the present invention relates to a system for automated matching of customer service representatives with customers based on their service requests.

### BACKGROUND OF THE INVENTION

When a customer contacts an organization regarding a service need, a service representative typically interfaces with the customer to address the customer's service needs. Many companies provide a generic customer service through the use of call centers and help desks. In these instances, customers call into the help center or approach a help desk to obtain assistance with their product. The employee of the company that is interfacing with the customer typically varies each time that the call center or help desk is contacted. If the request cannot be completely resolved in a single call or meeting, then the employee handling the customer service request may change in the majority of cases with each call or meeting.

Other companies offer dedicated customer service representatives to some customers and for certain products. A particular representative may be assigned to service requests from a particular company or customer. In this manner, the customer may form an established relationship with their customer representatives. These customer representatives, however, may not be the most knowledgeable or up-to-date on many of the issues faced by the customer, especially if the customer uses a wide range of the company's products or if the products are particularly complex or change rapidly, such as through software updates.

Some companies offer a combination of these services to their costumers. Regardless of the combinations offered, however, these options are generally and usually minimally automated. The specific customer service requests, sometimes referred to as tickets, can be logged and tracked in a system. This allows different customer service representatives to review the progress and status of the customer service requests and proceed accordingly. The customer service requests are assigned by placement in queues and serviced in order of request receipt or priority. The next available customer service representative takes the request at the front of the queue or it is manually assigned to the next available customer service representative.

Furthermore, when a customer contacts an organization regarding a service need, a service representative typically interfaces with the customer to address the customer's service need. During such person-to-person interface between the customer and the service representative, various difficulties may arise. For example, the native languages of the customer and the service representative may be different. Therefore, the language barriers may prohibit effective and efficient exchanges between the customers and the service representatives.

Another example is when the service representatives may not relate to the particular concern of the customers. In a situation where the customers are enthusiastic about certain product lines or brands, the customers' need may involve service relating to those certain product lines or brands. If the service representatives are unfamiliar with those certain product lines or brands or with the needs related to those product lines or brands, the service representatives' unfamiliarity may impair effective and efficient exchange between the customers and the service representatives in such a niche market.

Accordingly, it is desirable to facilitate effective and efficient person-to-person exchanges between the customers and the service representatives. Such person-to-person exchanges between the customers and the service representatives can be facilitated when the attributes of the service representatives can be utilized to correspond to the specific needs of the customers. For example, it may be desirable to have service representatives fluent in the customers' native languages to interface with the customers. As another example, it may be desirable to have representatives who have expertise in the same product lines or brands as the customers to interface with said customers.

However, matching service representative attributes with customer needs is not easily accomplished. Furthermore, in many situations matching the service representative attributes with customer needs must be done in a very short period of time. For example, if the customer calls into the organization's call center with a service need, then there will be relatively little time to locate a service representative with attributes that matches the customer's needs if the customer is to be serviced in a timely manner.

### OBJECTIVE OF THE INVENTION

Accordingly, it is an object of the invention to provide an efficient and effective customer service representative.

It is also an object of the invention to provide customers with various mediums to access service representatives to fulfill their service needs. More specifically, the customers may use a phone, internet connection, real-world queuing, etc. to connect to the service representative.

It is also an object of the invention to obtain a profile of the service representatives based on various criteria, wherein the information may be indexed, cross-referenced, and stored in a database.

It is also an object of the invention to provide various criteria from which customers may select the preferred service representative, wherein the customers are matched with the best-matched service representative. The criteria may include time (fastest response), highest rating (rated from a variety of sources), language ability, geographical location, gender, nationality, expertise (specialization), standardized test results, social graph, etc.

It is also an object of the invention to allow the customers to select the preferred criteria using different input methods, such as touch tone devices (e.g. phone), web enabled device (e.g. computer), physical world input, etc.

It is also an object of the invention to allow the criteria chosen by the customers to be entered into the database and matched with those of the service representatives, wherein the service representative best matching the chosen criteria will be selected.

It is also an object of the invention to connect the customers with the corresponding service representative to service the needs of the customers.

### SUMMARY OF THE INVENTION

A method to facilitate customer service support is disclosed wherein a host computer matches one or more service representatives with one or more customers based on one or more service representative attributes of the service representatives and one or more customer attributes of the customers. In one embodiment, the service representative attributes are comprised of response time of the service representatives, satisfaction rating of the service representatives, language spoken by the service representatives, experience of the service representatives, subject acumen of the service representatives, geographical location of the service representatives, ethnic background of the service representatives, and gender of the service representatives.

In one embodiment, the customer attributes are comprised of language spoken by the customers, inquiry subject of the customers, geographical location of the customers, ethnic background of the customers, gender of the customers, available wait time of the customers and speed of response time required by the customers. In one embodiment, the customers and the service representatives and the host computer is connected via internet. In one embodiment, the host computer matches the customers with the service representative based on the largest amount of matching service representative attributes to customer attributes. In one embodiment, the host computer matches the customers with the service representative based on a predetermined algorithm. In one embodiment, the algorithm can be adjusted by a host computer user. In one embodiment, the algorithm assigns different priorities to one or more service representative attributes. In one embodiment, the algorithm assigns different priorities to one or more customer attributes. In one embodiment, the customers can override the host computer and manually match the service representatives to their likings. In one embodiment, the customers can adjust the algorithm.

### BRIEF DESCRIPTION OF THE DRAWINGS

These and other features and advantages of the invention will not be described with reference to the drawings of certain preferred embodiments, which are intended to illustrate and not to limit the invention, and in which:

FIG. 1 is a high level flow chart illustrating the sequence of events regarding the process of the customer service representatives selection mechanism of the present invention disclosed herein.

FIG. 2 is a high level flow chart illustrating the process of connecting each customer service representative to the customer.

FIG. 3 is a high level drawing of the customer support system in connecting the customer to the service representative.

FIG. 4 is a high level diagram illustrating the primary components of the service representative selection method based on various specific criteria.

FIG. 5 is a flow chart illustrating the sequence of events from the view of the service representative in connecting and providing service to a customer.

FIG. 6 is a flow chart illustrating the sequence of events of servicing the needs of the customer from the point of view of a customer service representative.

FIG. 7 is a flow chart illustrating the sequence of events of connecting the best-matched customer service representative with the customer according to his or her selection criteria for service representatives.

FIG. 8 is the screen illustration of a real-world interaction for the customer to select the desired criteria in the service representative.

FIG. 9 is the screen illustration of an internet enabled interaction for the customer to select the desired criteria in the service representative.

FIG. 10 is high level drawing symbolizing the criteria selection in reaching the best-matched customer service representative.

### DETAIL DESCRIPTION OF THE INVENTION

Systems and methods of providing customer support are disclosed. An exemplary embodiment compares a plurality of customers' service needs with corresponding ones of a plurality of service representative attributes to identify the “best match” service representative.

A method and system can match consumers based on their needs to service representatives with predetermined attributes. Initially, a database of pre-screened, pre-qualified service representatives is established, wherein certain screening criteria are used and service representatives profile information is gathered. These criteria may include time (fastest response), highest rating (based on a variety of sources), language spoken, seniority (experience), taste/subjective preferences, geographical location, gender, nationality, expertise, standardized test results, social graph, etc. This profile information is developed and optimized to be indexed in a database.

Customers may interact with their service representatives using a number of different mediums including telephone, internet connection, real world queuing, etc. Upon connection via the customers' preferred medium, the customers may select the preferred criteria via a number of different input methods, including, but not limited to, touch tone device (e.g. phone, cellular phone, etc.), web enabled device (e.g. laptops, internet-enabled television, smart-phones), physical world inputs (e.g. in person consultation), etc.

In one embodiment, the customers may use a phone and, via touch tone or voice recognition, input the desired criteria, wherein the criteria entered into the database is matched to the profiles of pre-qualified service representatives in the system. The service representative with the best-matched profile is, then, connected with the customer for the most efficient and effective service.

In another embodiment, the customers may choose the preferred criteria of service representatives via web enabled devices such as computers, tablets, or smart-phones. The customers' preferred criteria of service representatives are entered into the database, wherein the criteria is matched to the profiles of pre-qualified service representatives in the system. The customers are matched to their corresponding service representative according to their profiles for the most efficient and effective service.

In yet another embodiment, the customers may enter a store or consult a help desk, wherein the customers may choose the preferred criteria of service representatives through real-world (physical world) inputs, such as paper and pencil or verbal communication. The criteria are entered into the database to determine the best fit profiles of service representatives, wherein the customers are matched with the corresponding service representatives for the most efficient and effective service.

### DETAILED DESCRIPTION OF THE DRAWINGS

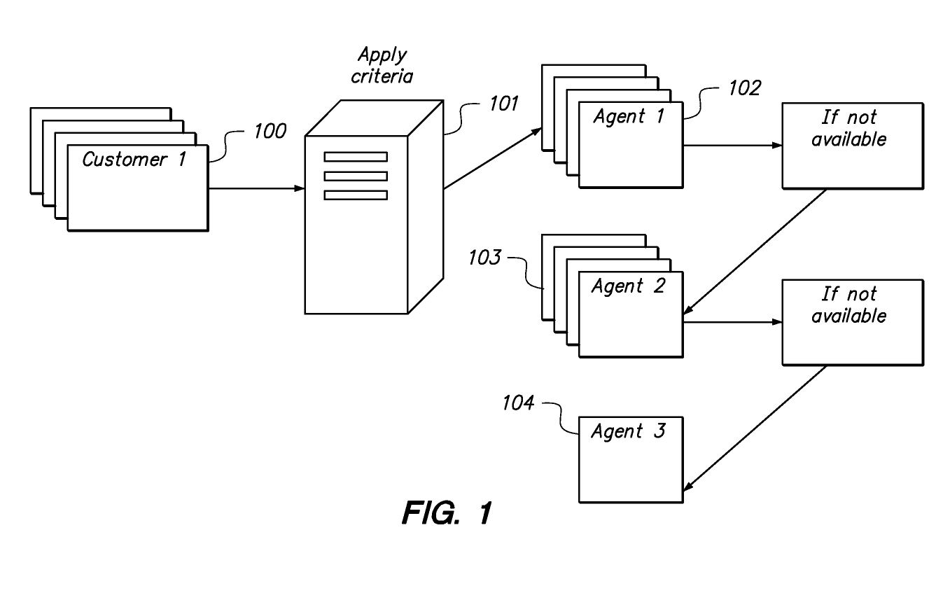

FIG. 1 illustrates the general sequence of customers 100, through the preferred medium, such as telephone or computer, connecting with the service representative system 101, wherein the criteria provided by the customer will be applied. The system, with access to a database containing profiles of all the service representatives or agents, will filter the service representatives using the customer-generated list of criteria. The group of service representatives who best-matched the criteria 102 are the preferred service representative for the customer 100. If none of the best-matched service representatives 102 are available, the agents in the next group 103 closest to matching the criteria provided by the customer 100 are chosen. If none of those agents in the next group 103 are available, the agents in the next group 104 closest to matching the criteria provided by the customer 100 are chosen, and so on.

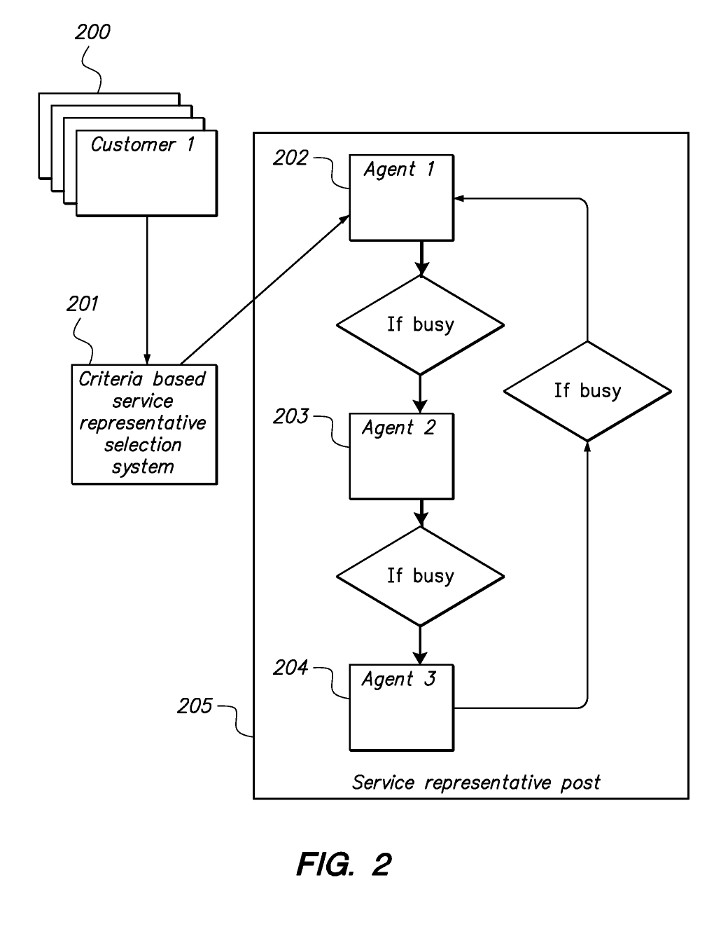

FIG. 2 illustrates the general sequence of customers 200 being connected to a service representative from the service representative pool 205 who matches the criteria as supplied by the customer 200 and applied by the system 201 as disclosed in the invention herein. The customer 200 provides the desired criteria, from which the system 201 will apply the criteria and compare it to profiles of the service representatives stored in the database. The group of service representatives matching the criteria will form a service representative pool 205 from which the customer's needs can be serviced. Within the service representatives in the pool 205, a service representative is selected 202. If that service representative 202 is unavailable, another service representative 203 equally matching the criteria set out by the customer is selected. If that service representative 203 is unavailable, yet another service representative 204 equally matching the criteria set out by the customer is selected, and so on.

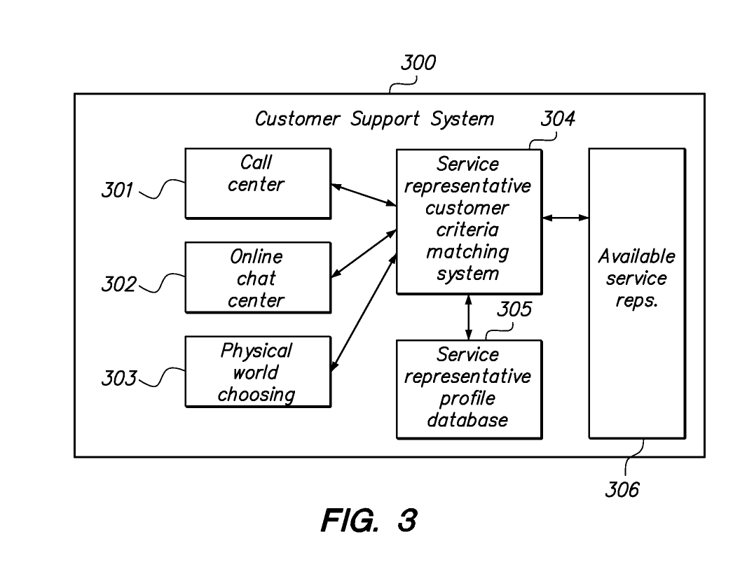

FIG. 3 illustrates the architectural drawing of the customer support system 300, wherein it is comprised of a medium of interaction, such as through a telephone to a call center 301, a web enabled device to an online chat center 302, or in-person by physical world choosing 303. Next, the customer chosen criteria is applied by the system 304, which matches the criteria to the profiles of the service representatives stored in a database 305, wherein a service representative matching the criteria will be selected from the pool of available service representatives 306.

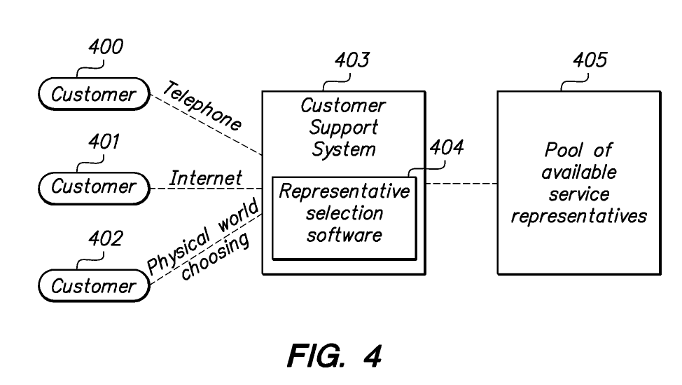

FIG. 4 illustrates a flow chart of the customer support process, wherein the customers 400, 401, 402 may, through the desired medium of interaction, connect to the customer support system 403. The customer support system 403, using the data of criteria provided by the customers 400, 401, 402 and the data on the profiles of the service representatives, can process both sets of data through representative selection software 404, whereby the best-matched service representative is selected from the pool of available service representatives 405 and connected with the customer.

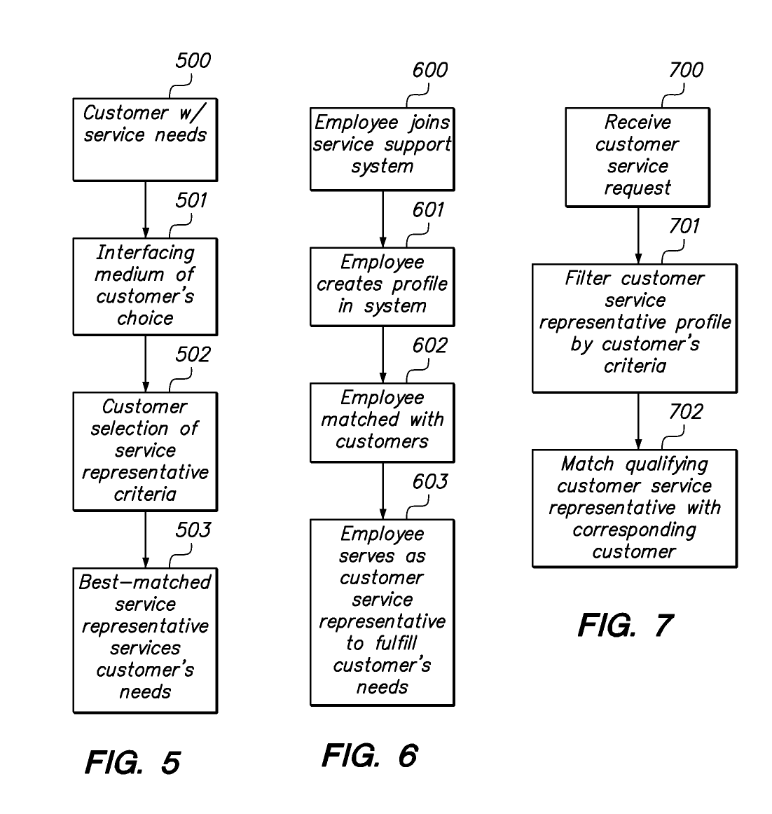

FIG. 5 illustrates a flow chart of the steps necessary for the customer 500 with a service need to reach the best-matched service representative 503. The customer 500, using the preferred medium 501 of the customer's choice, selects the desired criteria of the service representatives 502 to service his or her needs, and the system analyzes the information and selects the best-matched service representative 503 to the customer 500.

FIG. 6 illustrates a flow chart of the steps necessary for an employee to become a service representative in the customer service support system. First, the employee must join the system 600; next, the employee must create his or her profile and input into the system for processing 602 to become a service representative, wherein the data is stored in a database. Then, once the service representative is selected by the system and matched to the customer 602, the service representative can began to service the needs of the customer desiring a service representative matching the exact set of criteria 603.

FIG. 7 illustrates a flow chart of the steps necessary for the service representative support system to connect the desired service representative to the corresponding customer. First, a customer service request from a customer is received by the system 700, wherein the system filters the pool of service representatives based on the profiles stored in the database and cross-references with the criteria provided by the customer 701. Finally, the system selects the service representative best matching the provided criteria, and connecting the service representative to the customer for interface 702.

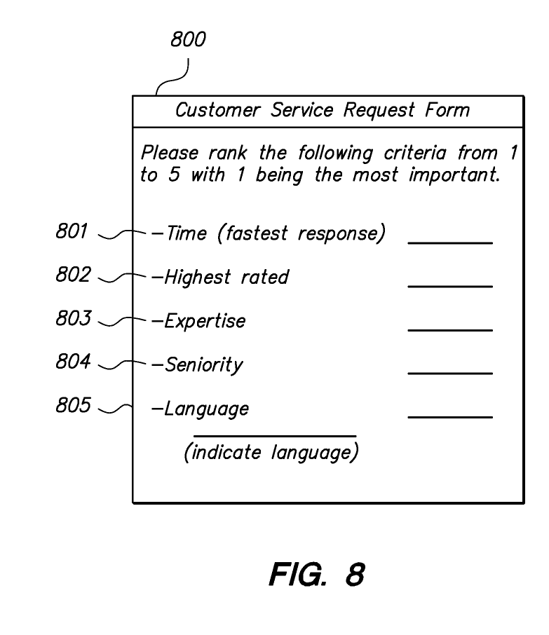

FIG. 8 is a screen illustration of an embodiment of a type of physical world choosing 800, wherein the customer seeking service from a service representative provides the criteria desired of a service representative by ranking the specific criteria with a form 800, wherein the criteria may include, but not limited to, the response time of the service representative 801, the rating of service representative 802, the expertise of the service representative 803, the experience of the service representative 804, and the language in which the service representative is proficient 805. Upon the selection of the criteria by the customer, the customer service support system may then process the data provided by the form 800 into the system to match the customer with the best-suited service representative available.

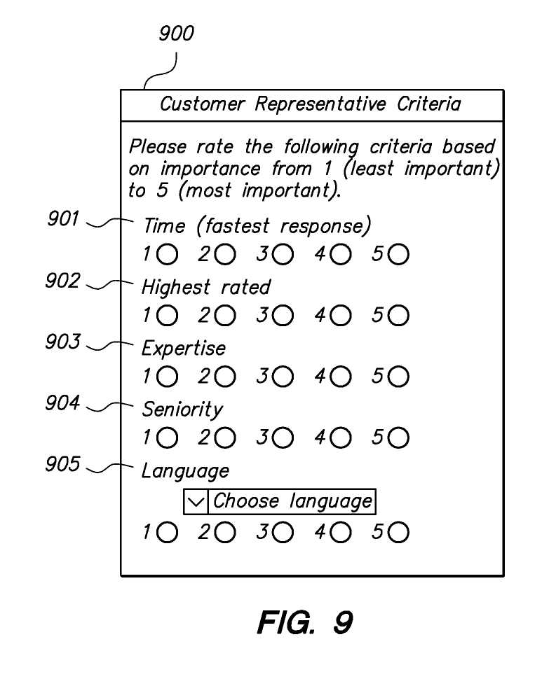

FIG. 9 is a screen illustration of an embodiment of a type of web enabled interactive form 900, wherein the customer seeking service from a service representative provides the criteria desired of a service representative by ranking the specific criteria with a form 900, wherein the criteria may include, but is not limited to, the response time of the service representative 901, the rating of service representative 902, the expertise of the service representative 903, the experience of the service representative 904, and the language in which the service representative is proficient 905. Upon the selection of the criteria by the customer, the customer service support system may then process the data provided by the form 900 into the system to match the customer with the best-suited service representative available.

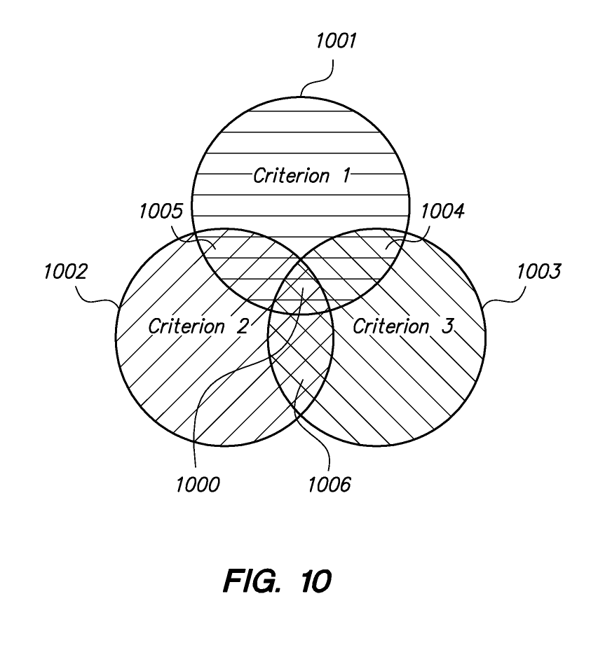

FIG. 10 is a Venn diagram illustrating the visual representation of the customer service representative support system in analyzing and selecting the pool of service representatives matching the criteria 1000. Each criterion is a specific trait or characteristic desired by the customer, such as the response time of the service representative, the rating of service representative, the expertise of the service representative, the experience of the service representative, or the language in which the service representative is proficient. As such, those service representatives who satisfies the first criterion 1001 is overlapped with those satisfying criterion 2 1002, upon which they are overlapped with those satisfying criterion 3 1003, wherein those matching all criteria 1000 are selected. If none of the service representatives matching all criteria 1000 are available, those next best match the given criteria 1004, 1005, 1006 are selected to be match with the customer to provide service.

1. A method to facilitate customer service support wherein a host computer matches one or more service representatives with one or more customers based on one or more service representative attributes of said service representatives and one or more customer attributes of said customers.

2. The method of claim 1 wherein said service representative attributes are comprised of response time of said service representatives, satisfaction rating of said service representatives, language spoken of said service representatives, experience of said service representatives, subject acumen of said service representatives, geographical location of said service representatives, ethnic background of said service representatives and gender of said service representatives.

3. The method of claim 1 wherein said customer attributes are comprised of language spoken of said customers, inquiry subject of said customers, geographical location of said customers, ethnic background of said customers, gender of said customers, available wait time of said customers and speed of response time required by said customers.

4. The method of claim 1 wherein said customers and said service representatives and said host computer is connected via internet.

5. The method of claim 1 wherein said host computer matches said customers with said service representative based on the largest amount of matching service representative attributes to customer attributes.

6. The method of claim 1 wherein said host computer matches said customers with said service representative based on a predetermined algorithm.

7. The method of claim 6 wherein said algorithm can be adjusted by a host computer user.

8. The method of claim 6 wherein said algorithm assigns different priorities to one or more service representative attributes.

9. The method of claim 6 wherein said algorithm assigns different priorities to one or more customer attributes.

10. The method of claim 1 wherein said customers can override said host computer and manually match said service representatives to their likings.

11. The method of claim 6 wherein said customers adjust said algorithm.

12. A system to facilitate customer service support comprising
a. a host computer,
b. one or more service representatives,
c. one or more customers
d. wherein a host computer matches said service representatives with said customers based on one or more service representative attributes of said service representatives and one or more customer attributes of said customers.

13. The system of claim 12 wherein said service representative attributes are comprised of response time of said service representatives, satisfaction rating of said service representatives, language spoken of said service representatives, experience of said service representatives, subject acumen of said service representatives, geographical location of said service representatives, ethnic background of said service representatives and gender of said service representatives.

14. The system of claim 12 wherein said customer attributes are comprised of language spoken of said customers, inquiry subject of said customers, geographical location of said customers, ethnic background of said customers, gender of said customers, available wait time of said customers and speed of response time required by said customers.

15. The system of claim 12 wherein said customers and said service representatives and said host computer is connected via internet.

16. The system of claim 12 wherein said host computer matches said customers with said service representative base on the largest amount of matching service representative attributes to customer attributes.

17. The system of claim 12 wherein said host computer matches said customers with said service representative base on a predetermined algorithm.

18. The system of claim 17 wherein said algorithm can be adjusted by a host computer user.

19. The system of claim 17 wherein said algorithm assigns different priorities to one or more service representative attributes.

20. The system of claim 17 wherein said algorithm assigns different priorities to one or more customer attributes.

21. The system of claim 12 wherein said customers can override said host computer and manually match said service representatives to their likings.

22. The system of claim 17 wherein said customers adjust said algorithm.
